(19) United States
(12) Patent Application Publication
(10) Pub. No.: US 2021/0300338 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/209,781

(22) Filed: Mar. 23, 2021

(30) Foreign Application Priority Data
Mar. 30, 2020 (JP) 2020-061637

(51) Int. Cl. B60W 30/06; G08G 1/00; G06Q 50/30; G06Q 10/02

(52) U.S. Cl. CPC B60W 30/06; G08G 1/20; G06Q 10/02; G06Q 50/30; G08G 1/22

(57) ABSTRACT

A parking lot management device includes a communicator capable of communicating with a terminal device of a user of a vehicle and the vehicle, a determination unit for determining whether user information for identifying the user and vehicle information for identifying the vehicle correspond to each other when the communicator receives information for moving the vehicle from the terminal device, and a permission unit which allows the vehicle to move to a target position based on a determination result of the determination unit. When the communicator receives information from the terminal device to move vehicles including a user vehicle and another vehicle different from the user vehicle, the determination unit determines an association degree indicating a relationship between the user vehicle and the another vehicle and the permission unit permits movement of the vehicles to respective target positions based on a determination result regarding the association degree.

### CROSS-REFERENCE TO RELATED APPLICATIONS

The present application claims the benefit of priority of Japanese Patent Application No. 2020-061637, filed on Mar. 30, 2020, the content of which is incorporated herein by reference.

### TECHNICAL FIELD

The present invention relates to an accommodation area management device which manages an accommodation area capable of accommodating a moving body.

### BACKGROUND

JP-A-2007-219738 discloses a technique in which a self-driving control device which controls automatic traveling of a vehicle automatically travels the vehicle to a predetermined parking frame and parks the vehicle based on parking information from a parking information management device.

### SUMMARY

However, in a related art, a technique for collectively managing or operating a plurality of moving bodies in an accommodation area for accommodating a moving body such as a vehicle has not been sufficiently studied and there is room for improvement in this respect.

The present invention provides an accommodation area management device which enables a plurality of moving bodies to be collectively managed or operated in an accommodation area for accommodating the moving body.

The first aspect of a present embodiment is an accommodation area management device which manages an accommodation area for accommodating a moving body, comprising:

a communicator configured to communicate with a terminal device of a user of the moving body and the moving body:

a determination unit configured to determine whether user information for identifying the user and moving body information for identifying the moving body correspond to each other when the communicator receives information for moving the moving body from the terminal device; and

a permission unit configured to allow the moving body to move to a target position based on a determination result of the determination unit, wherein

when the communicator receives information from the terminal device to move a plurality of moving bodies including a user moving body of the user and another moving body different from the user moving body, the determination unit determines a degree of association indicating a relationship between the user moving body and the another moving body and the permission unit permits movement of the plurality of moving bodies to respective target positions based on a determination result regarding the degree of association of the determination unit.

The second aspect of a present embodiment is an accommodation area management device which manages an accommodation area for accommodating a moving body, comprising:

a communicator configured to communicate with a terminal device of a user of the moving body and the moving body:

a determination unit configured to determine whether user information for identifying the user and moving body information for identifying the moving body correspond to each other when the communicator receives information for moving the moving body from the terminal device; and

a permission unit configured to allow the moving body to move to a target position based on a determination result of the determination unit, wherein

when the communicator receives information from the terminal device to move a plurality of moving bodies including a user moving body of the user and another moving body different from the user moving body, the determination unit determines a degree of association indicating a relationship between the user moving body and the another moving body and the permission unit groups the plurality of moving bodies and collectively controls the moving bodies based on a determination result regarding the degree of association of the determination unit.

According to the present embodiment, in the accommodation area for accommodating the moving body, it is possible to collectively manage or operate the plurality of moving bodies by an operation of one user.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking reservation table.

FIG. 5 is a diagram illustrating an example of a parking space status table.

FIG. 6 is a diagram illustrating an example of a group affiliation information table.

FIG. 7 is a flowchart (No. 1) illustrating a series of processing flows of the parking lot management device.

FIG. 8 is a flowchart (No. 2) illustrating a series of processing flows of the parking lot management device.

### DESCRIPTION OF EMBODIMENT

Hereinafter, an embodiment of an accommodation area management device of the invention will be described with reference to the accompanying drawings. In the following embodiment, an example will be described in which a moving body in the invention is a vehicle and an accommodation area in the invention is a parking lot. Further, in the following embodiment, an example in which the accommodation area management device of the invention is used as a parking lot management device for managing a parking lot will be described.

Vehicle System

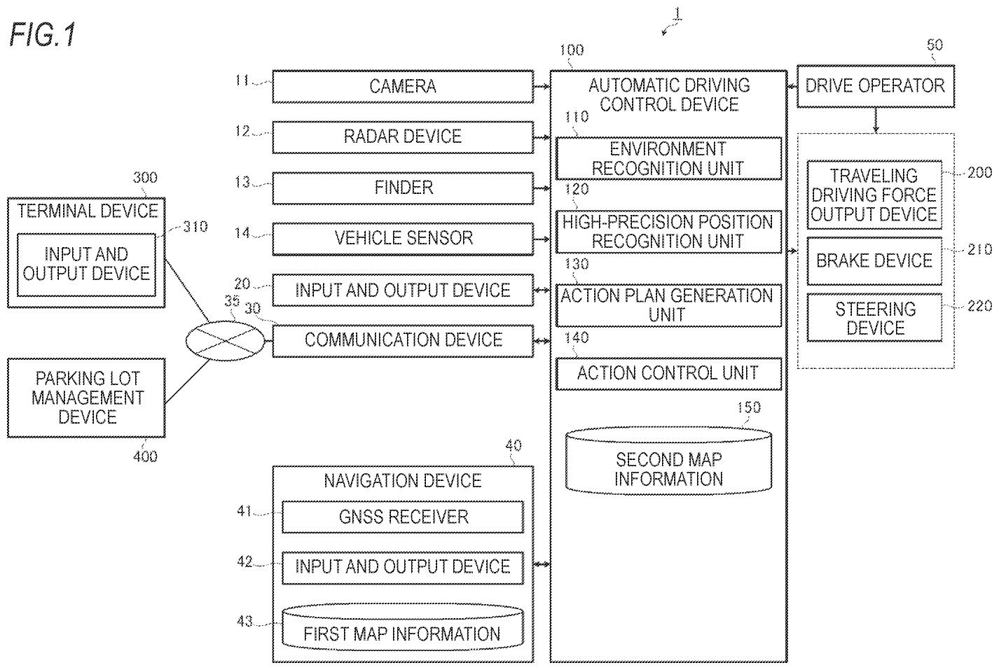

First, a vehicle of the embodiment will be described. In FIG. 1, a vehicle system 1 is mounted on a vehicle having an automatic driving function of a so-called automatic driving level “4” or higher. A vehicle (hereinafter, also referred to as vehicle M) equipped with the vehicle system 1 is a vehicle including a drive source and wheels (for example, two wheels, three wheels, or four wheels) including driving wheels driven by the power of the drive source. The drive source of the vehicle M is, for example, an electric motor. Further, the drive source of the vehicle M may be an internal combustion engine such as a gasoline engine or a combination of an electric motor and an internal combustion engine.

As illustrated in FIG. 1, the vehicle system 1 includes a camera 11, a radar device 12, a finder 13, a vehicle sensor 14, an input and output device 20, a communication device 30, a navigation device 40, a drive operator 50, an automatic driving control device 100, a traveling driving force output device 200, a brake device 210, and a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M. and the like. Further, the vehicle sensor 14 includes a radio wave intensity sensor which detects the radio wave intensity (that is, the communication intensity) of the radio wave used by the communication device 30, described later, for communication. The vehicle sensor 14 outputs the detection result of each sensor to the automatic driving control device 100 or the like.

The input and output device 20 includes an output device which outputs various kinds of information to a user of the vehicle M and an input device which accepts various input operations from the user of the vehicle M. The output device of the input and output device 20 is, for example, a display which displays based on a processing result of the automatic driving control device 100. The output device may be a speaker, a buzzer, an indicator light, or the like. The input device of the input and output device 20 is, for example, a touch panel or an operation button (key, switch, or the like) which outputs an operation signal corresponding to an input operation received from a user to the automatic driving control device 100.

The communication device 30 is connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M, a parking lot management device 400 which manages a parking lot PA where the vehicle M can be parked. The terminal device 300 is, for example, a smartphone or a tablet terminal and is an electronic device connected to the network 35 and including an input and output device 310. The input and output device 310 is, for example, a display which displays various information to a user, a touch panel which accepts a user's input operation, and the like. The parking lot PA and the parking lot management device 400 will be described below.

The navigation device 40 includes a Global Navigation Satellite System (GNSS) receiver 41 and an input and output device 42. Further, the navigation device 40 includes a storage device (not illustrated) such as a flash memory and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user of the vehicle M and an input device which accepts various input operations from a user of the vehicle M. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

For example, the navigation device 40 determines a route (hereinafter, also referred to as a route on the map) from the position of the vehicle M specified by the GNSS receiver 41 to a destination input by the user with reference to the first map information 43. Then, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by the function of the terminal device 300. Also, for example, the communication device 30 may transmit information indicating the position of the vehicle M and the destination input by a user to a server device (navigation server) outside the vehicle system 1 and the function of the navigation device 40 may be realized by this server device.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction of the steering wheels.

Automatic Driving Control Device

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space in the parking lot PA with reference to the second map information 150.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processing Unit (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processing Unit (GPU), and for example, the storage device for storing the second map information 150 and the high-precision position recognition unit 120 may be realized by a Map Positioning Unit (MPU). Further, a part or all of the functional units of the automatic driving control device 100 may be realized by the cooperation of software and hardware.

Parking Lot Managed by Parking Lot Management Device

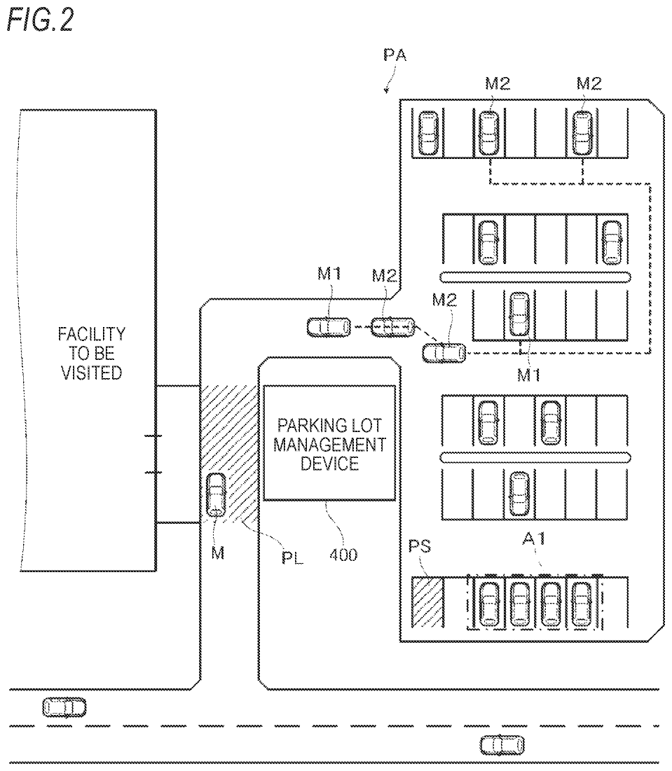

Next, an example of the parking lot PA will be described with reference to FIG. 2. As illustrated in FIG. 2, the parking lot PA is a parking lot managed by the parking lot management device 400 and is an automatic valet parking type parking lot attached to a visited facility to be visited by a user. The parking lot PA includes a plurality of parking spaces PS where a vehicle (for example, vehicle M) can be accommodated and a platform PL provided right before the plurality of parking spaces PS. Hereinafter, an example in which a user of the vehicle M uses the parking lot PA will be described.

Before using the parking lot PA, a user of the vehicle M makes a reservation for using the parking lot PA to the parking lot management device 400 which manages the parking lot PA by using own terminal device 300 or the like. For example, the user inputs own identification information (for example, a user ID described below), the identification information (for example, the vehicle ID described below) of the vehicle M to be parked, a date and time when the parking lot PA is used (for example, a reserved time zone described below), and the like to the terminal device 300 and transmits this information to the parking lot management device 400, in such a manner that the user makes a reservation for using the parking lot PA. Then, when the date and time of the reservation is reached, the user drives the vehicle M to the platform PL and gets off from the vehicle M at the platform PL.

After the user gets off the vehicle M, the vehicle M automatically drives and starts a self-propelled parking event to move to the parking space PS in the parking lot PA. For example, the user sends a request to start a self-propelled entry event to move the vehicle M to the parking space PS to the parking lot management device 400 by using own terminal device 300 or the like. In response to the request to start the self-propelled entry event, the parking lot management device 400 instructs the vehicle M to perform the self-propelled entry event to park in a predetermined parking space PS. According to this instruction, the vehicle M moves to the parking space PS instructed by the parking lot management device 400 while performing guiding by the parking lot management device 400 and sensing with the camera 11, the radar device 12, the finder 13, or the like.

In addition, the vehicle M parked in the parking lot PA can carry out re-parking, so-called “reparking”, in which the parking position is changed to another parking position in the parking lot PA. Reparking is appropriately carried out by a control instruction by the parking lot management device 400 or a voluntary automatic driving by the vehicle M itself.

In addition, at the time of exit from the parking lot PA, the vehicle M is automatically driven and performs a self-propelled exit event to move from the parked parking space PS to the platform PL. For example, the user uses own terminal device 300 or the like to send a request for starting the self-propelled exit event to move the vehicle M to the platform PL to the parking lot management device 400. In response to the request to start the self-propelled exit event, the parking lot management device 400 instructs vehicle M to perform the self-propelled exit event to move the vehicle M from the parked parking space PS to the platform PL. According to this instruction, the vehicle M moves to the platform PL while performing guiding by the parking lot management device 400 and sensing with the camera 11, the radar device 12, the finder 13, or the like. Then, the user gets on the vehicle M which has reached the platform PL and exits from the parking lot PA.

Parking Lot Management Device

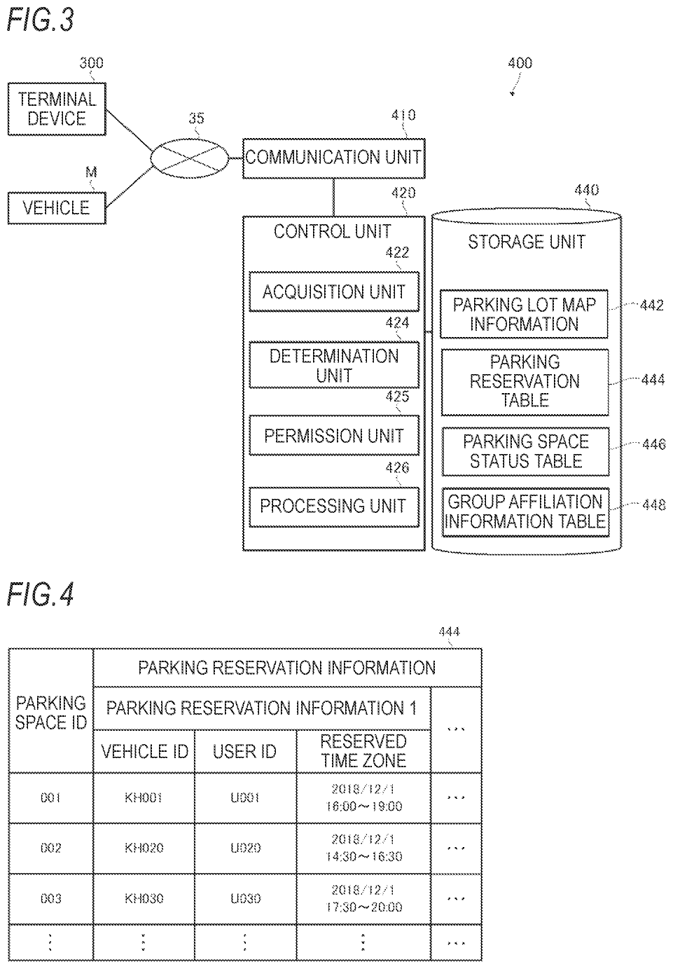

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a determination unit 424, a permission unit 425, and a processing unit 426. Each component of the control unit 420 is realized, for example, by a hardware processor such as a CPU executing a program (software). Some or all of those components may be realized by hardware (circuit part; including circuitry) such as LSI, ASIC, FPGA, and GPU, or may be realized by collaboration between software and hardware. The program may be stored in advance in a storage device (a storage device including a non-transient storage medium) such as an HDD or a flash memory, or the program may be stored in a removable storage medium (non-transient storage medium) such as a DVD or a CD-ROM and installed by attaching the storage medium to a drive device.

The storage unit 440 stores information such as parking lot map information 442, parking reservation table 444, a parking space status table 446, and a group affiliation information table 448. The storage unit 440 is realized by an HDD, a flash memory, or the like.

The communication unit 410 wirelessly (for example, network 35) communicates with the vehicle M, the terminal device 300 of the user, and the like. The control unit 420 controls the movement of the vehicle M in the parking lot PA by, for example, guiding the vehicle M to the parking space PS based on the information acquired by the communication unit 410 and the information stored in the storage unit 440. The parking lot map information 442 is information which geometrically represents the structure of the parking lot PA. Further, the parking lot map information 442 includes the coordinates for each parking space PS.

A parking reservation for the vehicle M is input to the acquisition unit 422 from the terminal device 300 of the user of the vehicle M using the communication unit 410. When the parking reservation of the vehicle M is input, the acquisition unit 422 registers the input parking reservation in the parking reservation table 444 of the storage unit 440.

As illustrated in FIG. 4, the parking reservation table 444 stores, for example, the parking reservation information in association with a parking space ID, which is identification information of the parking space PS. The parking reservation information includes, for example, the vehicle ID which is identification information of the vehicle M to be parked, the user ID which is identification information of a user of the vehicle M, and information indicating the reserved time zone when the vehicle M is scheduled to be parked in the parking lot PA.

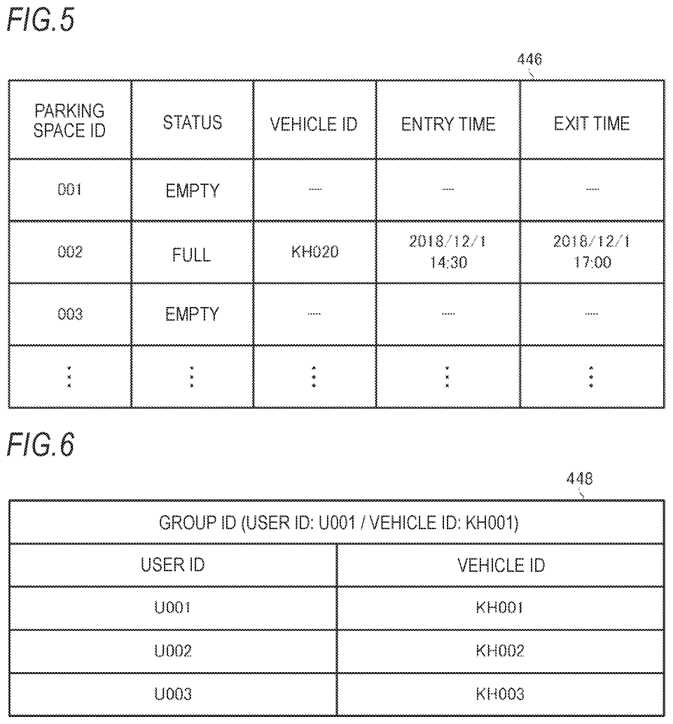

Further, the acquisition unit 422 can also acquire the position information of each vehicle M parked in the parking lot PA via the communication unit 410. This position information is stored, for example, in the form of the parking space status table 446. As illustrated in FIG. 5, in the parking space status table 446, the parking space ID, which is the identification information of the space PS, is associated with information indicating whether the parking space PS is empty or full, the Vehicle ID, which is the identification information of the parked vehicle M when the parking space PS is full, and the entry time and exit time (scheduled exit time) of the vehicle M when the parking space PS is full. The entry time and exit time are recorded, for example, in association with the vehicle ID of the vehicle M when the vehicle M enters the parking lot PA. The vehicle ID can be, for example, a vehicle number written on a vehicle number plate (so-called license plate).

In addition, the acquisition unit 422 can also acquire the position information of each vehicle M traveling in the parking lot PA. For example, the vehicle M traveling in the parking lot PA periodically transmits information which associates the vehicle ID of the own vehicle with the position (for example, the position recognized by the high-precision position recognition unit 120) of the own vehicle in the parking lot PA to the parking lot management device 400. The acquisition unit 422 acquires information in which the vehicle ID transmitted from the vehicle M traveling in the parking lot PA and the position in the parking lot PA are associated with each other via the communication unit 410. Further, when the parking lot management device 400 receives the information in which the vehicle ID and the position in the parking lot PA are associated with each other from the vehicle M traveling in the parking lot PA, the parking lot management device 400 may store the received information in a predetermined table of the storage unit 440. Then, the acquisition unit 422 may acquire the position information of the vehicle M traveling in the parking lot PA with reference to this table.

By the way, there are various purposes for a user to park the vehicle M in the parking lot PA. For example, there is a case where a user uses the parking lot PA to visit a visited facility with a friend (one or two or more people). Then, in such a case, each person may ride on a separate vehicle M and gather at the parking lot PA. In such a case, instead of each person making a reservation for the parking lot PA, one user may want to make a reservation for everyone at once, and by accepting such usage reservations, it is considered that the convenience of the user in using the parking lot PA will be increased. In addition, when each person parks the own vehicle M at an arbitrary parking position in the parking lot PA, it is considered that the convenience of the parking lot management device 400 will be increased by allowing one user to collectively make an exit operation for each person's vehicle M so that all members can exit the vehicles M from the parking lot PA at the same time.

Therefore. When the parking lot management device 400 of the embodiment receives information from the terminal device 300 of a user of a vehicle M to move (for example, enter or exit) a vehicle M (hereafter, also referred to as another vehicle M) of another user in addition to a user vehicle which is the vehicle M of the user, the parking lot management device 400 of the embodiment determines the degree of association indicating the relationship between the user and another user, and then allows the plurality of vehicles M to move their respective target positions based on the determination result. Alternatively, when the parking lot management device 400 receives information from the terminal device 300 of a user of a vehicle M to move a vehicle M of another user in addition to a user vehicle which is the vehicle M of the user, the parking lot management device 400 determines the degree of association indicating the relationship between the user and another user, and based on the determination result, groups those a plurality of vehicles M and collectively controls them.

Therefore, the parking lot management device 400 can move or collectively control the vehicles M of users having some relation with each other, for example, the vehicles M of friends, and thus it is possible to improve the convenience of the user when using the parking lot PA. For example, the parking lot management device 400 enables one user to make a usage reservation of the parking lot PA for all members at once, or to perform an exit operation of the vehicles M for all members from the parking lot PA at once, and thus it is possible to improve the convenience of the user.

Here, first, processing of the parking lot management device 400 at the time of making a plurality of vehicles M to enter the parking lot PA will be described. For example, it is assumed that the communication unit 410 receives information from the terminal device 300 of a specific user to move a plurality of vehicles M including a user vehicle M1 of the specific user and other vehicles M2 other than the user vehicle M1. The information received by the communication unit 410 at this time is, for example, information including a user ID of the specific user (that is, the user of the user vehicle M1) and a vehicle ID of the user vehicle M1. Here, the user ID is an example of user information in the invention and the vehicle ID is an example of moving body information in the invention.

In this case, the determination unit 424 determines whether the user ID (that is, user information) of the specific user corresponds to the vehicle ID (that is, moving body information) of the user vehicle M1 based on the above-described information received by the communication unit 410. For example, the determination unit 424 can determine whether the user ID of the specific user and the vehicle ID of the user vehicle M1 correspond to each other by referring to the parking reservation table 444. More specifically, when the combination of the user ID and the vehicle ID of the above-described information received by the communication unit 410 matches the combination of the user ID and the vehicle ID stored in the parking reservation table 444 as parking reservation information, the determination unit 424 determines that the user ID of the specific user corresponds to the vehicle ID of the user vehicle M1.

Further, when the communication unit 410 receives the information described above, the determination unit 424 determines the degree of association indicating the relationship between the user vehicle M1 and another vehicle M2. Then, based on the determination result of the determination unit 424, the permission unit 425 permits the movement of the plurality of vehicles M to the respective target positions, or groups the plurality of vehicles M and controls them collectively.

FIG. 6 illustrates the group affiliation information table 448 which records group affiliation information, which is an example of the degree of association indicating the relationship between the user vehicle M1 and another vehicle M2. The table 448 records, for example, group affiliation information in which a user ID (“U001” in an illustrated example) of a specific user and a vehicle ID (“KH001”) of the user vehicle M1 are associated with and a user ID of another user and a vehicle ID of another vehicle M2.

The group affiliation information of the example illustrated in FIG. 6 indicates that a group of the user vehicle M1 (vehicle with vehicle ID (“KH001”)) of a specific user whose user ID is “U001” includes a vehicle with a vehicle ID “KH002” and a vehicle with a vehicle ID “KH003” as other vehicles M2. That is, the group affiliation information indicates that the user vehicle M1 with the vehicle ID “KH001”, a first other vehicle M2 with the vehicle ID “KH002”, and a second other vehicle M2 with the vehicle ID “KH003” belong to the same group.

In addition, the group affiliation information of the example illustrated in FIG. 6 indicates that the user of the user vehicle M1 with the vehicle ID “KH001” is a user with a user ID “U001” and the user of the first other vehicle M2 with the vehicle ID “KHO02” is a user with a user ID “U002”, and further the user of the second other vehicle M2 with the vehicle ID “KH003” is a user with a user ID “U003”. Further, the group affiliation information of the example illustrated in FIG. 6 indicates that the user (that is, the specific user) with the user ID “U001”, the user with the user ID “U002”, and the user with the user ID “U003” belong to the same group.

For example, in the group affiliation information, the users who belong to the same group are, for example, family members, friends, colleagues, or the like, who are allowed (accepted) to join the group. Further, for example, the parking lot management device 400 may communicate with a Social Networking Service (SNS) server to store the group affiliation information in which the users belonging to the same group in the SNS are set as the same group in the group affiliation information table 448.

Further, in the example illustrated in FIG. 6, the user ID of the specific user and the vehicle ID of the user vehicle M1 are used as the group identification information for identifying the group, but the invention is not limited to this. As the group identification information, for example, any group ID or group name can be used.

Further, the group affiliation information table 448 may be stored in advance in the storage unit 440, or may be appropriately stored and updated in the storage unit 440. For example, when transmitting information for moving a plurality of vehicles M including the user vehicle M1 and another vehicle M2, the group affiliation information table 448 may be combined with the information and transmitted from the terminal device 300. In this case, the communication unit 410 may receive that information and store it in the storage unit 440.

The determination unit 424 can refer to the group affiliation information table 448 and determine whether the user vehicle M1 and another vehicle M2 belong to the same group based on the group affiliation information which is an example of the degree of association. Then, when it is determined by the determination unit 424 that the vehicles belong to the same group, the permission unit 425 permits the movement of a plurality of vehicles M including the user vehicle M1 and another vehicle M2 to the respective target positions. By using such group affiliation information, it is possible to smoothly group the plurality of vehicles M which should be grouped.

Further, it is desirable that the communication unit 410 receives the group affiliation information at the time of making a reservation for using the parking lot PA for the user vehicle M1 and another vehicle M2, or at the time of entering the parking lot PA. That is, when the group affiliation information table 448 is not stored in the storage unit 440 in advance, the user uses the terminal device 300 or the like to send group affiliation information to the parking lot management device 400 when making a reservation for using the parking lot PA for the user vehicle M1 and another vehicle M2 or when entering the parking lot PA and the group affiliation information is stored in the storage unit 440 via the communication unit 410, in such a manner that the parking lot management device 400 can perform grouping processing smoothly.

Further, in the parking lot management device 400, when setting the target positions of a plurality of vehicles M belonging to the same group, it is desirable to set respective target positions within a predetermined distance. For example, when setting the parking positions in the parking lot PA of a plurality of vehicles M as the target positions of the plurality of vehicles M belonging to the same group, the parking lot management device 400 ensures that these plurality of vehicles M are parked within a predetermined distance, as illustrated in an area A1 of FIG. 2. In other words, the parking lot management device 400 makes the parking spaces PS where those a plurality of vehicles M are parked close to each other. As a result, when the plurality of vehicles M belonging to the same group are made to exit from the parking spaces PS, these vehicles M can smoothly exit from the parking spaces PS together. Further, the parking lot management device 400 may stop the plurality of vehicles M within a predetermined distance on the platform PL when, for example, the plurality of vehicles M belonging to the same group exit from the parking spaces PS.

The above mainly describes processing at the time of making the plurality of vehicles M enter the parking spaces PS.

Next, processing of the parking lot management device 400 at the time of making a plurality of vehicles M exit from the parking spaces PS will be described. The following description of a plurality of vehicles M at the time of exiting from the parking lot PA is an example of a case where the user vehicle M1 and two other vehicles M2 illustrated in FIG. 2 are to exit from the parking lot PA. As illustrated in FIG. 2, here, it is assumed that the user vehicle M1 and the two other vehicles M2 are parked at different separate positions, for example. Here, for convenience, an example in which a specific one of those three vehicles is set as the user vehicle M1 will be described, but the user vehicle M1 may be any of those three vehicles.

First, the user of the user vehicle M1 operates own terminal device 300 or the like and sends a group creation request to the parking lot management device 400 to create a group consisting of a plurality of vehicles M including the user vehicle M1 and other vehicles M2. In making the group creation request, for example, the terminal device 300 of the user of the user vehicle M1 displays a list of each vehicle M parked in the parking lot PA. Then, the user of the user vehicle M1 selects a vehicle M (that is, other vehicles M2) to be grouped with the user vehicle M1 from this list. When other vehicles M2 are selected by the user of the user vehicle M1, the terminal device 300 sends a group creation request to the parking lot management device 400 to create a group including the user vehicle M1 and other vehicles M2 selected.

For example, the above list can be a list representing the vehicle ID (for example, vehicle number), the vehicle model name, color, and the like of each vehicle M. As a result, the user of the user vehicle M1 can select other vehicles M2 while referring to the vehicle ID, the vehicle model name, color, and the like of each vehicle M. Also, instead of such a list, a map which simply illustrates the parking lot PA (for example, each parking space PS) and the position of each vehicle M parked in the parking lot PA may be displayed on the terminal device 300. In this case, the user of the user vehicle M1 can select the vehicle M by tapping the vehicle M to be selected as other vehicles M2 among the vehicles M displayed on the map, for example. Also, when the vehicle M to be select as other vehicle M2 is tapped, the vehicle ID, the vehicle model name, color, and the like of the vehicle M may be displayed and a message confirming whether to select the vehicle M may be displayed. Further, the user of the user vehicle M1 may be able to select other vehicles M2 based on the information (for example, the vehicle IDs of other vehicles M2) notified from other users who desire grouping to the terminal device 300 of the user of the user vehicle M1.

When the communication unit 410 receives the group creation request, it sends an inquiry notification asking whether to join the group created by the user of the user vehicle M1 to the terminal devices 300 of other users who are users of other vehicles M2. Then, in response to the inquiry notification, when permission information to join the group is received from other users, the permission unit 425 groups a plurality of vehicles M including the user vehicle M1 and other vehicles M2 of other users. As a result, it is possible to create a group based on the intention of each user of the plurality of vehicles M. Further, for example, a plurality of vehicles M which are not grouped at the time of entering the parking spaces PS can be grouped according to a request from a user of those vehicles M, and thus it is possible to prepare for the smooth exit of those a plurality of vehicles M from the parking spaces PS together.

In addition, when receiving disapproval information from other users not to join the group in response to the inquiry notification, the permission unit 425 does not group the user vehicle M1 with other vehicles M2 of other users. In this case, for example, the parking lot management device 400 notifies the terminal device 300 of the user of the user vehicle M1 and the terminal devices 300 of other users that grouping is not performed via the communication unit 410. Also, when the communication unit 410 does not receive the permission information and the non-permission information within a specified time after the inquiry notification, the permission unit 425 may not group the user vehicle M1 with other vehicles M2 of other users.

The processing unit 426 performs a process of moving the vehicle M. The processing unit 426 moves the vehicle M to the target position by instructing the vehicle M to move to the predetermined target position, for example. In this case, the processing unit 426 may also determine a suitable route to the target position and instruct the vehicle M to move by this route. Further, here, the target position can be a position set by the parking lot management device 400 or a position specified by the user of the vehicle M.

For example, the user transmits a desired parking position (parking space PS) to the parking lot management device 400 by the terminal device 300 or the like at the time of making a reservation for using the parking lot PA or when entering the parking lot PA. In this case, when it is possible to park the vehicle M at the parking position specified by the user, the parking lot management device 400 sets the parking position as the target position of the vehicle M. Further, the parking lot management device 400 sets, for example, an arbitrary parking position in which the vehicle M can be parked as a target position of the vehicle M when the parking position is not specified by the user.

In addition, at the time of exiting from the parking space PS, the platform PL is generally set as the target position. When there are a plurality of platforms PL, the user transmits the platform PL to which the vehicle M is called at the time of exiting from the parking lot PA to the parking lot management device 400 by the terminal device 300 or the like. In this case, the parking lot management device 400 sets the platform PL specified by the user as the target position of the vehicle M. The processing unit 426 moves the vehicle M to the target position set in this way.

Further, when the processing unit 426 moves a plurality of vehicles M belonging to the same group, it is desirable to make the plurality of vehicles M travel in a convoy. For example, as illustrated by the broken line in FIG. 2, when the user vehicle M1 and two other vehicles M2 parked at different positions are made to exit from the parking spaces PS, the processing unit 426 makes those three vehicles M travel by forming a convoy in which the three vehicles M are arranged in front and behind, with the user vehicle M1 at the head. As a result, the plurality of vehicles M belonging to the same group can be smoothly traveled.

Further, the processing unit 426 may form a convoy based on the specifications and performance of a plurality of vehicles M belonging to the same group. Here, the specifications of the vehicle M include the vehicle type, the size, the minimum turning radius, and the like and the performance includes the set traveling speed, which is an upper limit of the speed during automatic driving. By determining the traveling order of each vehicle M in the convoy based on such specifications and performance, the convoy can be moved smoothly. Specifically, for example, by arranging the vehicle M having a high set traveling speed in the front and the vehicle M having a low set traveling speed in the rear, smooth movement in the entire convoy can be ensured.

Further, as described above, it is desirable that the processing unit 426 arranges the user vehicle M1 at the head, that is, the vehicle M of the user who has made the exit request described below at the head of the convoy. As a result, the user who has made the exit request can easily find own vehicle M.

Also, when the processing unit 426 needs to repark the vehicle M parked in the parking lot PA, the processing unit 426 may determine a new parking position (new target position) with reference to the parking space status table 446. In this case, the processing unit 426 may also determine a suitable route to the new parking position. The target position and route determined by the processing unit 426 are transmitted to the vehicle M using the communication unit 410.

In the vehicle M which has received the target position and route, the action plan generation unit 130 generates an action plan (for example, a target track), and then the vehicle M is controlled by the action control unit 140 so that the vehicle M acts according to the action plan generated by the action plan generation unit 130. As a result, the vehicle M moves to the target position.

Processing Flow

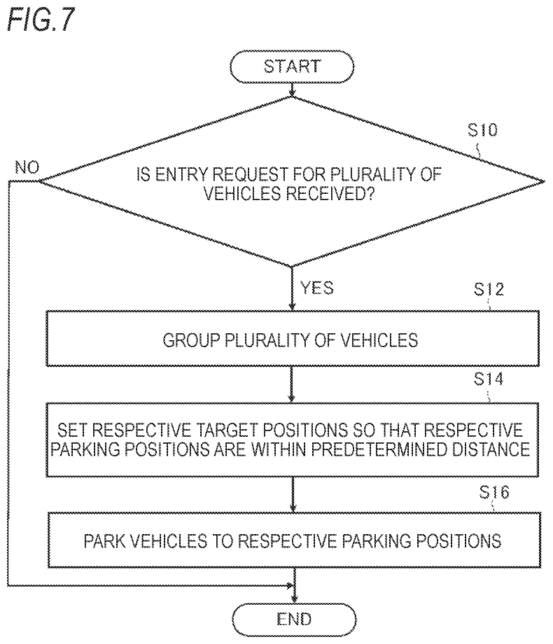

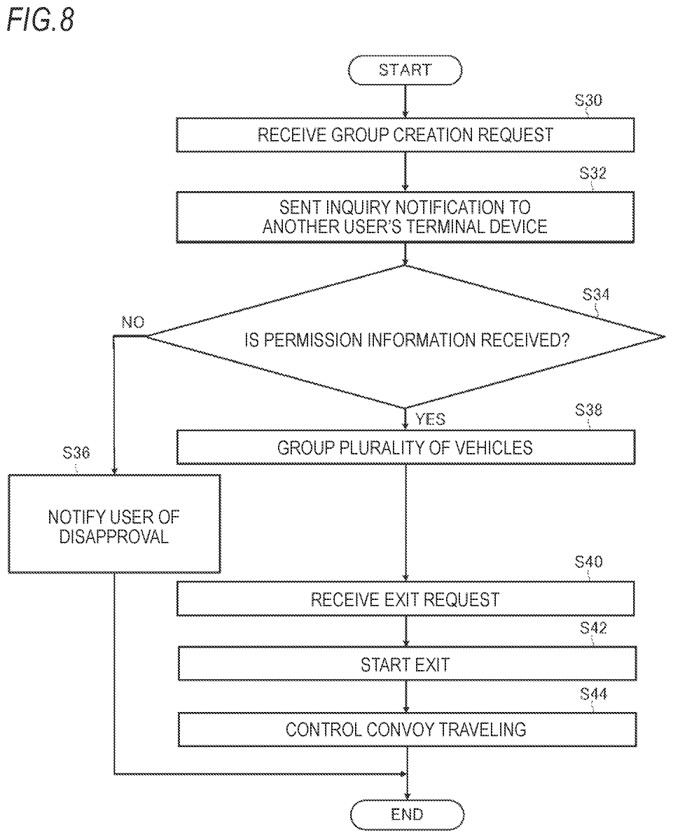

Hereinafter, a series of processing flows of the parking lot management device 400 will be described with reference to FIGS. 7 and 8. Processes illustrated in FIGS. 7 and 8 may be repeated at a predetermined cycle. FIG. 7 is an example of a processing flow when a plurality of vehicles M are collectively made to enter the parking spaces PS.

First, the parking lot management device 400 determines whether an entry request for making a plurality of vehicles M including the user vehicle M1 and other vehicles M2 enter the parking spaces PS has been received from the terminal device 300 of the user (Step S10). When the entry request for making the plurality of vehicles M enter the parking spaces PS is not received (NO in Step S10), the parking lot management device 400 ends the process illustrated in FIG. 7.

Upon receiving the entry request to make the plurality of vehicles M to enter the parking spaces PS (YES in Step S10), the parking lot management device 400 groups the plurality of vehicles M including the user vehicle M1 and other vehicles M2 (Step S12). In Step S12, the parking lot management device 400 stores, for example, group affiliation information in which the plurality of vehicles M including the user vehicle M1 and other vehicles M2 are in the same group in the group affiliation information table 448.

Then, the parking lot management device 400 sets each target position so that the parking positions of the plurality of vehicles M including the grouped user vehicle M1 and other vehicles M2 are within a predetermined distance (Step S14). In Step S14, the parking lot management device 400 stores, for example, parking reservation information for the user vehicle M1 and other vehicles M2 in the parking reservation table 444. In this case, the parking lot management device 400 stores the parking reservation information of the plurality of vehicles M including the user vehicle M1 and other vehicles M2 in association with the parking spaces ID of the adjacent parking spaces PS. As a result, the parking positions of the plurality of vehicles M including the user vehicle M1 and other vehicles M2 are secured and the movement of those a plurality of vehicles M to the parking positions (that is, the target positions) is permitted.

Then, when the plurality of vehicles M including the user vehicle M1 and other vehicle M2 enter the parking lot PA, the parking lot management device 400 makes the plurality of vehicles M be parked at the set parking positions (Step S16), and then the process illustrated in FIG. 7 ends.

FIG. 8 is an example of a processing flow when the plurality of vehicles M are collectively made to exit from the parking spaces PS. When the management device 400 receives a group creation request from the terminal device 300 of the user (Step S30), the management device 400 sends an inquiry notification as to whether to join the user-created group to the terminal devices 300 of other users (Step S32).

Then, the parking lot management device 400 determines whether the permission information, that is, the intention to join the group created by the user is received from the terminal devices 300 of other users as a response to the inquiry notification (Step S34). When receiving disapproval information not to join the group created by the user (NO in Step S34), the parking lot management device 400 notifies the terminal device 300 of the user that other users will not join the group created by the user (Step S36), and then the process illustrated in FIG. 8 ends. In this case, the parking lot management device 400 may also notify the terminal devices 300 of other users that other users will not join the group.

When permission information to join the group created by the user is received (YES in Step S34), the parking lot management device 400 groups the plurality of vehicles M including the user vehicle M1 of the user and other vehicles M2 of other users (Step S38). In Step S38, the parking lot management device 400 stores, for example, group affiliation information in which the plurality of vehicles M including the user vehicle M1 and other vehicles M2 are in the same group in the group affiliation information table 448.

Then, when the parking lot management device 400 receives an exit request from the terminal device 300 of the user to make the plurality of vehicles M including the user vehicle M1 and other vehicles M2 exit from the parking spaces PS (Step S40), the exit of those plurality of vehicles M is started (Step S42). In this case, the permission unit 425 may set temporary parking positions in order to put together the plurality of vehicles M. Further, the processing unit 426 may move the plurality of vehicles M to the temporary parking positions.

Then, the parking lot management device 400 causes the plurality of vehicles M to exit from the parking lot PA while controlling the convoy traveling of the plurality of vehicles M including the user vehicle M1 and other vehicles M2 (Step S44), and then the process illustrated in FIG. 8 ends. Further, in Step S44, the parking lot management device 400 may arrange the user vehicle M1 at the head of the convoy.

The embodiment described above is an example in which the moving body is a vehicle and the accommodation area is a parking lot. However, the idea of the invention is not limited to such an embodiment and is also applied to a moving body (for example, a robot) other than a vehicle. That is, under the concept of the invention, “parking” is extended to the concept of “stop” and “traveling” is extended to the concept of “movement”, and further the “parking lot management device” of the embodiment is extended to the concept of “accommodation area management device”. The repark also includes an operation of “restopping to change the accommodation position of the stopped moving body to another accommodation position in the accommodation area” or “the stopped moving body moves to another accommodation position in the accommodation area and stops again”.

The embodiment for carrying out the invention is described above using the embodiment. However, the invention is not limited to the embodiments and various modifications and substitutions can be made without departing from the gist of the invention.

In addition, at least the following matters are described in this specification. The components and the like corresponding to those in the embodiment described above are shown in parentheses, but the invention is not limited thereto.

(1) An accommodation area management device (parking lot management device 400) which manages an accommodation area (parking lot PA) for accommodating a moving body (vehicle M), including:

a communicator (communication unit 410) capable of communicating with a terminal device (terminal device 300) of a user of the moving body and the moving body;

a determination unit (determination unit 424) for determining whether user information for identifying the user and moving body information for identifying the moving body correspond to each other when the communicator receives information for moving the moving body from the terminal device; and

a permission unit (permission unit 425) which allows the moving body to move to a target position based on a determination result of the determination unit, where

when the communicator receives information from the terminal device to move a plurality of moving bodies including a user moving body of the user and another moving body different from the user moving body, the determination unit determines a degree of association indicating a relationship between the user moving body and the another moving body and the permission unit permits movement of the plurality of moving bodies to respective target positions based on a determination result regarding the degree of association of the determination unit.

According to (1), it is possible to collectively manage related moving bodies.

(2) An accommodation area management device (parking lot management device 400) which manages an accommodation area (parking lot PA) for accommodating a moving body (vehicle M), including:
a communicator (communication unit 410) capable of communicating with a terminal device (terminal device 300) of a user of the moving body and the moving body;
a determination unit (determination unit 424) for determining whether user information for identifying the user and moving body information for identifying the moving body correspond to each other when the communicator receives information for moving the moving body from the terminal device; and
a permission unit (permission unit 425) which allows the moving body to move to a target position based on a determination result of the determination unit, where
when the communicator receives information from the terminal device to move a plurality of moving bodies including a user moving body of the user and another moving body different from the user moving body, the determination unit determines a degree of association indicating a relationship between the user moving body and the another moving body and the permission unit groups the plurality of moving bodies and collectively controls the moving bodies based on a determination result regarding the degree of association of the determination unit.

According to (2), it is possible to collectively control related moving bodies.

(3) The accommodation area management device according to (1) or (2), where

the determination unit determines whether the user moving body and the another moving body belong to a same group in determination of the degree of association.

According to (3), the plurality of moving bodies can be appropriately grouped together.

(4) The accommodation area management device according to (3), where

the communicator receives group affiliation information indicating whether the user moving body and the another moving body belong to the same group from the terminal device at the time of either reservation of the accommodation area or entry into the accommodation area, and

the determination unit determines whether the user moving body and the another moving body belong to the same group based on the group affiliation information.

According to (4), the plurality of moving bodies can be smoothly grouped.

(5) The accommodation area management device according to (3), where

the communicator sends an inquiry notification asking whether to join a group to a terminal device of another user who is a user of the another moving body when a group creation request for creating the group consisting of the plurality of moving bodies including the user moving body and the another moving body is received from the terminal device of the user of the user moving body, and

the permission unit groups the plurality of moving bodies including the user moving body and the moving body of another user into a same group when permission information to join the group is received from another user as a response to the inquiry notification.

According to (5), it is possible to create a group based on the intention of each user of the plurality of moving bodies.

(6) The accommodation area management device according to any one of (3) to (5), where

respective target positions are set within a predetermined distance when the respective target positions of the plurality of moving bodies belonging to the same group are set.

According to (6), it is possible to move the plurality of moving bodies together smoothly.

(7) The accommodation area management device according to any one of (3) to (6), where

the plurality of moving bodies belonging to the same group are moved in a convoy.

According to (7), it is possible to smoothly move the plurality of moving bodies belonging to the same group.

(8) The accommodation area management device according to (7), where

the convoy is a convoy based on specifications or performance of each of the plurality of moving bodies belonging to the same group.

According to (8), it is possible to move the entire convoy smoothly.

(9) The accommodation area management device according to any one of (1) to (8), where

the target position is a position set by the accommodation area management device or a position designated by the user.

According to (9), the moving body can be moved to an appropriate target position.

What is claimed is:

1. An accommodation area management device which manages an accommodation area for accommodating a moving body, comprising:
a communicator configured to communicate with a terminal device of a user of the moving body and the moving body;
a determination unit configured to determine whether user information for identifying the user and moving body information for identifying the moving body correspond to each other when the communicator receives information for moving the moving body from the terminal device; and
a permission unit configured to allow the moving body to move to a target position based on a determination result of the determination unit, wherein
when the communicator receives information from the terminal device to move a plurality of moving bodies including a user moving body of the user and another moving body different from the user moving body, the determination unit determines a degree of association indicating a relationship between the user moving body and the another moving body and the permission unit permits movement of the plurality of moving bodies to respective target positions based on a determination result regarding the degree of association of the determination unit.

2. An accommodation area management device which manages an accommodation area for accommodating a moving body, comprising:
a communicator configured to communicate with a terminal device of a user of the moving body and the moving body;
a determination unit configured to determine whether user information for identifying the user and moving body information for identifying the moving body correspond to each other when the communicator receives information for moving the moving body from the terminal device; and
a permission unit configured to allow the moving body to move to a target position based on a determination result of the determination unit, wherein
when the communicator receives information from the terminal device to move a plurality of moving bodies including a user moving body of the user and another moving body different from the user moving body, the determination unit determines a degree of association indicating a relationship between the user moving body and the another moving body and the permission unit groups the plurality of moving bodies and collectively controls the moving bodies based on a determination result regarding the degree of association of the determination unit.

3. The accommodation area management device according to claim 1, wherein
the determination unit determines whether the user moving body and the another moving body belong to a same group in determination of the degree of association.

4. The accommodation area management device according to claim 3, wherein
the communicator receives group affiliation information indicating whether the user moving body and the another moving body belong to the same group from the terminal device at the time of either reservation of the accommodation area or entry into the accommodation area, and
the determination unit determines whether the user moving body and the another moving body belong to the same group based on the group affiliation information.

5. The accommodation area management device according to claim 3, wherein
the communicator sends an inquiry notification asking whether to join a group to a terminal device of another user who is a user of the another moving body when a group creation request for creating the group consisting of the plurality of moving bodies including the user moving body and the another moving body is received from the terminal device of the user of the user moving body, and
the permission unit groups the plurality of moving bodies including the user moving body and the moving body of another user into a same group when permission information to join the group is received from another user as a response to the inquiry notification.

6. The accommodation area management device according to claim 3, wherein
respective target positions are set within a predetermined distance when the respective target positions of the plurality of moving bodies belonging to the same group are set.

7. The accommodation area management device according to claim 3, wherein
the plurality of moving bodies belonging to the same group are moved in a convoy.

8. The accommodation area management device according to claim 7, wherein
the convoy is a convoy based on specifications or performance of each of the plurality of moving bodies belonging to the same group.

9. The accommodation area management device according to claim 1, wherein
the target position is a position set by the accommodation area management device or a position designated by the user.
